(19) United States
(12) Patent Application Publication
(10) Pub. No.: US 2021/0387623 A1
(43) Pub. Date: Dec. 16, 2021

(54) SYSTEM AND METHOD FOR CONTROLLING A VEHICLE START-STOP SYSTEM

(71) Applicant: Lear Corporation, Southfield, MI (US)

(72) Inventors: Arjun YETUKURI, Rochester Hills, MI (US); Ashwini Jayanth MALATKAR, Troy, MI (US)

(73) Assignee: Lear Corporation, Southfield, MI (US)

(21) Appl. No.: 16/897,330

(22) Filed: Jun. 10, 2020

(51) Int. Cl. B60W 30/18; B60W 40/04; B60W 50/14; G06K 9/00; G08G 1/16; H04W 4/40

(52) U.S. Cl. CPC B60W 30/18018; B60W 40/04; B60W 50/14; B60W 2050/143; G08G 1/16; H04W 4/40; B60W 2556/45; G06K 9/00805

(57) ABSTRACT

A control system and method are described for controlling a vehicle stop-start system having a stop stage in which an engine of a host vehicle is automatically stopped and a start stage in which the host vehicle engine is automatically restarted after the stop stage. The control system includes an interface configured to receive an input signal including traffic condition information, wherein the input signal includes a vehicle-to-x communication signal or a sensor signal from a host vehicle sensor adaptable to monitor a traffic condition. The control system also includes a controller configured to generate a control signal operative to automatically initiate the start stage of the vehicle stop-start system based on a determination that the traffic condition information of the input signal indicates an impending change in a traffic condition.

### TECHNICAL FIELD

The following relates to an improved system and method for controlling a host vehicle start-stop system based on a determination that traffic condition information indicates an impending change in a traffic condition.

### BACKGROUND

Start-stop systems for vehicle engines are well known in the automotive industry. In operation, after a driver of a vehicle equipped with a start-stop system operates the vehicle brake pedal and the vehicle is brought to a halt, an engine controller stops, shuts down, deactivates, or turns off the vehicle internal combustion engine, such as by cutting off fuel to the engine or halting the generation of sparks for igniting the fuel. Subsequently, when the driver of the vehicle releases the brake pedal, the engine controller starts, re-starts, activates, or turns on the vehicle engine to enable the vehicle to proceed.

Vehicle start-stop systems are provided to reduce fuel consumption and engine emissions. That is, by automatically stopping and restarting an internal combustion engine as described above, a vehicle start-stop system (which also may be referred to as a vehicle stop-start system) reduces engine emissions and improves fuel efficiency by automatically reducing the amount of time the vehicle engine spends idling. A vehicle start-stop system may thus be particularly beneficial for a vehicle that experiences long periods of time motionless at traffic lights or in congested traffic.

However, while vehicle start-stop systems aim to reduce emissions and improve fuel economy by stopping the engine when the vehicle is at rest, the start feature of such start-stop systems can be anything but seamless in many vehicles, which may lead to frustrations. In that regard, latency associated with the start feature of a vehicle start-stop system can cause delays in a vehicle driver starting to drive.

Moreover, unexpected outcomes of advanced features on modern vehicles, such as those of start-stop systems, can include delays caused by distracted drivers. In that regard, distracted driving has become an increasingly dangerous and costly problem due to various factors, including the proliferation of mobile devices and the use of such devices by vehicle drivers while driving. In 2016, distracted driving accounted for nearly 10% of fatalities on U.S. roads. Distracted driving can also be the cause of non-fatal accidents, delays, and even road rage.

One example of distracted driving is a vehicle stopped at a red traffic light and failing to proceed when the traffic light changes to green. While waiting at a red light for it to turn green, drivers often attend to non-driving activities. Eventually, when the light turns green, some drivers are in a distracted state and fail to realize that the light has turned green and the driver may therefore proceed. In a vehicle equipped with a start-stop system, waiting for a distracted driver to pay attention and release the vehicle brake pedal to initiate the start feature of that system can cause delays.

Such a situation may cause frustration for drivers in vehicles located behind the vehicle of the distracted driver. Such frustration may become manifest in honking and can potentially give rise to incidents of road rage between drivers. Such a situation may also create a false expectation in a driver that the driver in front will also start, which may result in a vehicle rear-end collision when the driver of the vehicle in front is distracted. Such a situation may alternatively result in minor to major traffic delays depending on the type, configuration, and/or congestion of an intersection and/or the lane in which the vehicle with the distracted driver is present (e.g., a left-turn only lane).

A need therefore exists for an improved system and method for controlling a vehicle start-stop system to solve, overcome, prevent, alleviate, address, eliminate, mitigate, or reduce some or all of the problems described above. In that regard, such an improved control system and method would receive traffic condition information from a vehicle-to-x communication signal or from a sensor signal from a host vehicle sensor adaptable to monitor a traffic condition. Such an improved control system and method would also automatically initiate the start stage of the vehicle stop-start system based on a determination that the traffic condition information indicates an impending change in a traffic condition. By initiating the start stage of a vehicle start-stop system in such a fashion, such an improved control system and method would reduce the latency of the start stage, which may help to eliminate accidents, improve traffic flow, and reduce the potential for road rage incidents.

### SUMMARY

According to one non-limiting exemplary embodiment described herein, a control system is provided for controlling a vehicle stop-start system having a stop stage in which an engine of a host vehicle is automatically stopped and a start stage in which the host vehicle engine is automatically restarted after the stop stage. The control system may comprise an interface configured to receive an input signal including traffic condition information, wherein the input signal comprises a vehicle-to-x communication signal or a sensor signal from a host vehicle sensor adaptable to monitor a traffic condition. The control system may further comprise a controller configured to generate a control signal operative to automatically initiate the start stage of the vehicle stop-start system based on a determination that the traffic condition information of the input signal indicates an impending change in a traffic condition.

According to another non-limiting exemplary embodiment described herein, a method is provided for controlling a vehicle stop-start system having a stop stage in which an engine of a host vehicle is automatically stopped and a start stage in which the host vehicle engine is automatically restarted after the stop stage. The method may comprise receiving an input signal including traffic condition information, wherein the input signal comprises a vehicle-to-x communication signal or a sensor signal from a host vehicle sensor adaptable to monitor a traffic condition. The method may further comprise generating a control signal operative to automatically initiate the start stage of the vehicle stop-start system based on a determination that the traffic condition information of the input signal indicates an impending change in a traffic condition.

According to still another non-limiting exemplary embodiment described herein, a non-transitory computer readable storage medium is provided having stored computer executable instructions for controlling a vehicle stop-start system having a stop stage in which an engine of a host vehicle is automatically stopped and a start stage in which the host vehicle engine is automatically restarted after the stop stage, the host vehicle having a controller and an interface configured to receive an input signal including traffic condition information, the input signal comprising a vehicle-to-x communication signal or a sensor signal from a host vehicle sensor adaptable to monitor a traffic condition. The computer executable instructions may be configured to cause the controller to generate a control signal operative to automatically initiate the start stage of the vehicle stop-start system based on a determination that the traffic condition information of the input signal indicates an impending change in a traffic condition.

A detailed description of these and other non-limiting exemplary embodiments of a system and method for controlling a vehicle stop-start system are set forth below together with the accompanying drawings.

### BRIEF DESCRIPTION OF THE DRAWINGS

FIG. 1 is an illustration of an exemplary environment for non-limiting exemplary embodiments of a system and method for controlling a vehicle stop-start system according to the present disclosure;

FIG. 2 is simplified block diagram of one non-limiting exemplary embodiment of a system for controlling a vehicle stop-start system according to the present disclosure; and

FIG. 3 is a simplified flowchart of one non-limiting exemplary embodiment of a method for controlling a vehicle stop-start system according to the present disclosure.

### DETAILED DESCRIPTION

As required, detailed non-limiting embodiments are disclosed herein. However, it is to be understood that the disclosed embodiments are merely exemplary and may take various and alternative forms. The figures are not necessarily to scale, and features may be exaggerated or minimized to show details of particular components, elements, features, items, members, parts, portions, or the like. Therefore, specific structural and functional details disclosed herein are not to be interpreted as limiting, but merely as a representative basis for teaching one skilled in the art.

As described previously, a need exists for an improved control system and method for controlling a vehicle start-stop system. Such an improved control system and method would receive traffic condition information from a vehicle-to-x communication signal or from a sensor signal from a host vehicle sensor adaptable to monitor a traffic condition. Such an improved control system and method would also automatically initiate the start stage of the vehicle stop-start system based on a determination that the traffic condition information indicates an impending change in a traffic condition. By initiating the start stage of a vehicle start-stop system in such a fashion, such an improved control system and method would reduce the latency of the start stage, which may help to eliminate accidents, improve traffic flow, and reduce the potential for road rage incidents.

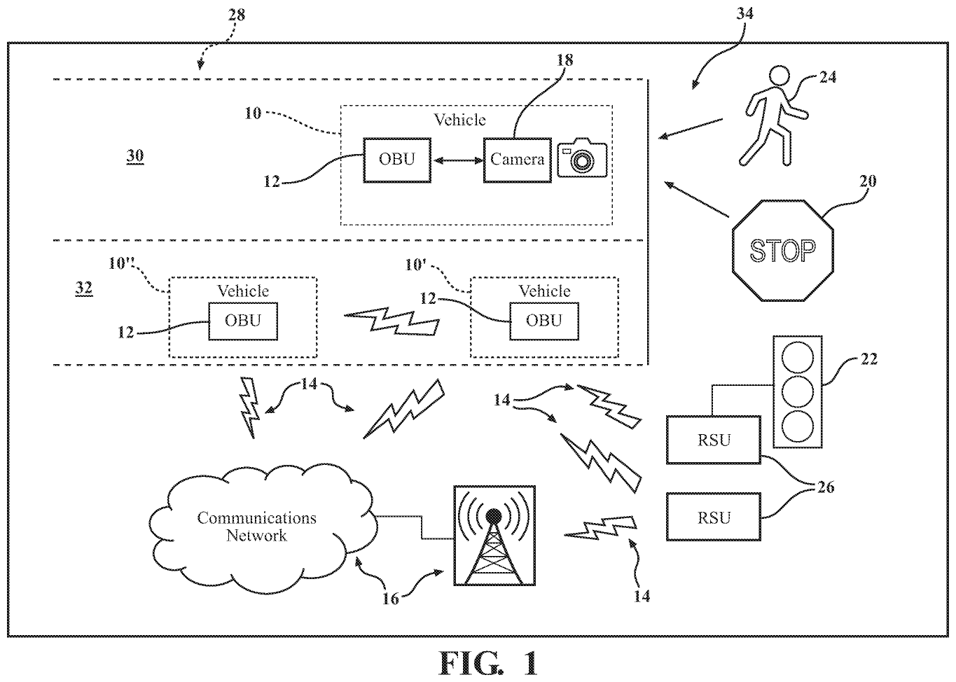

With reference now to FIGS. 1-3, a more detailed description will be provided of non-limiting exemplary embodiments of a system and method for controlling a vehicle stop-start system. For ease of illustration and to facilitate understanding, like reference numerals may be used herein for like components and features in the drawings.

In general, the improved system and method for controlling a vehicle start-stop system of the present disclosure compensate for the latency of the start feature or start portion of the vehicle start-stop system. The control system and method of the present disclosure may be integrated with a vehicle-to-x (V2X) system to gather information about the status of traffic lights and connected vehicles around the host vehicle. The V2X system may provide an anticipatory input indicating the impending status change of traffic signals.

For example, at an intersection, when a green light for cross traffic changes to yellow from green (or to red from yellow), such a change is an indication of an impending status change of the traffic light for a host vehicle from red to green. The control system and method of the present disclosure takes advantage of anticipatory input from a V2X system and initiates the start feature of the vehicle stop-stop system. This results in eliminating or reducing the delay in moving the host vehicle from rest and helps to solve, overcome, prevent, alleviate, address, eliminate, mitigate, or reduce some or all of the unwanted consequences described earlier.

Thus, according to the system and method of the present disclosure, when a traffic light for cross vehicle traffic (relative to a host vehicle) is or has changed to yellow, a signal may be sent to the host vehicle, for example via V2X, to start the engine of the host vehicle. Alternatively, when a traffic light for cross vehicle traffic is or has changed to yellow, a signal may be sent to the host vehicle, for example via V2X, to start the engine of the host vehicle in or after a predetermined period of time, such as a couple of seconds. As well, when a traffic light for the host vehicle changes to green, a signal may be sent to the host vehicle, for example via V2X, to start the engine of the host vehicle if the driver of the host vehicle has not already released the brake pedal of the host vehicle.

In that regard, the control system and method of the present disclosure pull ahead the start stage of a vehicle start-stop system by a small amount in terms of time, but the control system and method are not expected to have a significantly negative impact on the expected savings in fuel consumption provided by such start-stop systems, which estimates indicate may improve fuel economy from 3%-10%. Moreover, the control system and method of the present disclosure may have a positive impact on driving experience and safety.

Moreover, the control system and method of the present disclosure may initiate the start feature of a vehicle stop-start system just before it is safe for the host vehicle to execute a turn (e.g., a left turn) when at an intersection (either in a dedicated left turn lane or not) or when not at an intersection (e.g., a “Michigan” left turn). In that regard, the control system and method may utilize or include a V2X system or an outward facing camera or other sensor (e.g., RADAR, LIDAR, etc.) on-board the host vehicle to detect a traffic scenario, and an associated control module with intelligence (e.g., an Advanced Driver Assistance System (ADAS) or other vehicle control and/or autonomous driving systems) well known to those of ordinary skill to determine and/or identify a time to a safe-to-turn moment.

The control system and method of the present disclosure may also initiate the start feature of a vehicle start-stop system at a road intersection without traffic lights (e.g., a 4-way STOP) or when traffic signal lights are non-functional (e.g., due to power failure or malfunction). Here again, the control system and method may utilize or include a V2X system or an outward facing camera or other sensor (e.g., RADAR, LIDAR, etc.) on-board the host vehicle to detect a traffic scenario, and an associated control module with intelligence (e.g., an Advanced Driver Assistance System (ADAS) or other vehicle control and/or autonomous driving systems) well known to those of ordinary skill to determine and/or identify which vehicle arrived at the intersection first and/or has right-of-way according to the rules of the road to proceed through the intersection.

Further, the control system and method of the present disclosure may also initiate the start feature of a vehicle start-stop system just before it is safe for a host vehicle to proceed after the host vehicle has stopped for a pedestrian. Once again, the control system and method may utilize or include a V2X system or an outward facing camera or other sensor (e.g., RADAR, LIDAR, etc.) on-board the host vehicle to detect, identify and/or track a pedestrian, and an associated control module with intelligence (e.g., an Advanced Driver Assistance System (ADAS) or other vehicle control and/or autonomous driving systems) well known to those of ordinary skill to determine and/or identify that the pedestrian is about to pass and/or exit the intended path of the host vehicle and it will be safe for the pedestrian and the host vehicle to proceed.

The control system and method of the present disclosure may also initiate the start feature of a vehicle start-stop system just before it is possible for the host vehicle to move when stopped behind another vehicle because of a red light, a traffic jam, or at a 4-way STOP road intersection based on a determination that it is safe for the host vehicle to proceed when the vehicle in front of the host vehicle has left. In that regard, the control system and method may again utilize or include an outward facing camera or other sensor (e.g., RADAR, LIDAR, etc.) on-board the host vehicle to track the vehicle in front and an associated control module with intelligence (e.g., an Advanced Driver Assistance System (ADAS) or other vehicle control and/or autonomous driving systems) well known to those of ordinary skill to determine and/or identify that the vehicle in front is not or is no longer in the intended path of the host vehicle and it is safe for the host vehicle to proceed.

Still further, the control system and method of the present disclosure may also initiate the start feature of a vehicle start-stop system just before it is time to for the host vehicle to proceed when stopped at railway tracks and a railway gate is going to be lifted and/or a traffic light is going to turn green. Here again, the control system and method may again utilize or include a V2X system or an outward facing camera or other sensor (e.g., RADAR, LIDAR, etc.) on-board the host vehicle and an associated control module with intelligence (e.g., an Advanced Driver Assistance System (ADAS) or other vehicle control and/or autonomous driving systems) well known to those of ordinary skill to determine and/or identify that a railroad train has passed and/or the railway gate is about to be or is being lifted, or to determine or identify that the railway traffic light is about to turn green and it is safe for the host vehicle to proceed.

Thus, according to the control system and method of the present disclosure, when a V2X system sends a signal to the host vehicle that a traffic light at an intersection is going to turn green, the control system and method will attempt to activate the start feature of the host vehicle start-stop system. In an alternative embodiment of the control system and method, if the intersection is not clear or if the traffic ahead is backed up, even though the traffic light is about to turn or has turned green, the control system and method may delay activation or initiation of the start feature of the host vehicle start-stop system (i.e., delay turning ON the vehicle engine) even if the host vehicle driver has released the brake pedal. In that event, the control system and method may issue or cause to be issued an alert to the host vehicle driver indicative of the reason for not starting the host vehicle engine.

Optionally, the control system and method of the present disclosure may also issue or cause to be issued an alert to the host vehicle driver (ex: audio) before initiating the start feature of the vehicle start-stop system and/or starting the host vehicle engine. Moreover, the control system and method of the present disclosures may also optionally issue or cause to be issued an alert to the host vehicle driver (ex: audio) to release the vehicle brake pedal to enable the start feature of the host vehicle start-stop system.

In general, a driver alert issue or caused to be issued according to the system and method for controlling a host vehicle start-stop system of the present disclosure is a localized alert, which may be provided to the driver according to or associated with any of the example described herein. To do so, the control system and method of the present disclosure may utilize a haptic alert in the driver's seat of the vehicle, which may include one or more haptic motors and/or air bladders provided for use as part of a seat massage feature.

Alternatively, an audible and/or visual warning or alert may be provided to the driver, such as turning ON auxiliary/mood lights on the driver's seat or armrest. Such audible and/or visual alerts may be used along with or without any of the previously described haptic alerts. Still further, a driver alert may take the form of a seat function such as a front tilt mechanism that is automatically actuated without driver intervention, which may comprise activation of the mechanism at a higher travel rate than normal. When the vehicle is subsequently in motion, the activated feature may be returned to its original position.

According to the control system and method of the present disclosure, input regarding an impending change in a traffic light from red to green may be received by a seat control module from an outward facing camera or any other suitable type of sensor (e.g., a Light Detection and Ranging (LIDAR) sensor) on-board the host vehicle. Alternatively, input regarding an impending change in a traffic light from red to green may be received by a seat control module from one or more wireless communication signals transmitted/received in a wireless communication system, such as vehicle-to-anything (V2X) (e.g., vehicle-to-vehicle, vehicle-to-infrastructure, vehicle-to-pedestrian) Dedicated Short Range Communications (DSRC), cellular communications, or any other type of wireless communications. One example of such a wireless communication system is CONNEXUS' provided by Lear Corporation.

Referring now to FIG. 1, an exemplary environment is illustrated for non-limiting exemplary embodiments of a driver assistance method and system for alerting a driver of a host vehicle according to the present disclosure. As seen therein, a host vehicle 10, 10′, 10″ may include an on-board unit (OBU) 12 configured for wireless communication with other similarly configured vehicles 10, 10′, 10″ via wireless signals 14 transmitted between the OBUs 12. As previously noted, such wireless signals 14 may be DSRC signals transmitted directly between the OBUs 12 or may be any other type of wireless signal, such as a cellular communication signals transmitted via wireless communication network or system 16.

The OBUs 12 may also be configured for communication with a forward-facing camera 18 or any other type of suitable sensor (e.g., a LIDAR sensor) on-board the vehicle 10. Such an on-board camera 18 or sensor may sense, detect, and/or provide information regarding the environment around the vehicle 10, which may include detecting (e.g., by capturing images of) a traffic signal, such as a STOP sign 20 or a traffic control light 22, or detecting a pedestrian 24. Data or information provided by the camera 18 and/or other suitable on-board sensor and/or V2X communications may be used by a controller, control unit, or control module on-board the vehicle 10 to determine whether or not an object is present in front or in the planned path of the vehicle 10 and/or to identify any such object detected as a vehicle or a pedestrian, including determining and/or tracking the speed and direction of the detected object relative to the vehicle 10, according to any of the vehicle systems and methods for detecting, identifying, and/or tracking objects that are well known to those of ordinary skill.

Such OBUs 12 may also be configured for wireless communication with roadside units (RSU) 26 similarly configured for such wireless communication via wireless signals 14 transmitted between the OBUs 12 and the RSUs 26. In that regard, the RSUs 26 are so named because they may be located beside, around, or in the vicinity of a road 28. One or more of the RSUs 26 may be provided in communication with the traffic control light 22 and may communicate with the OBUs 12 directly via DSRC signals or alternatively via any other type of wireless signal 14, such as cellular communication signals transmitted via wireless communication network or system 16. As previously described, the wireless signals 14 transmitted from the RSUs 26 to the OBUs 12 may include data or information as to the status or condition of the traffic control light 22, such as a transition from a red light to a green light.

Still referring to FIG. 1, the vehicles 10, 10′, 10″ may be located in a lane 30, 32 of the road 28 and may be stopped or stationary at an intersection 34 associated with the road 28. In that regard, a vehicle 10, 10′, 10″ may be the first vehicle 10, 10′ at the intersection 34 (first at intersection) or may not be the first vehicle 10″ at the intersection 34 (not first at intersection).

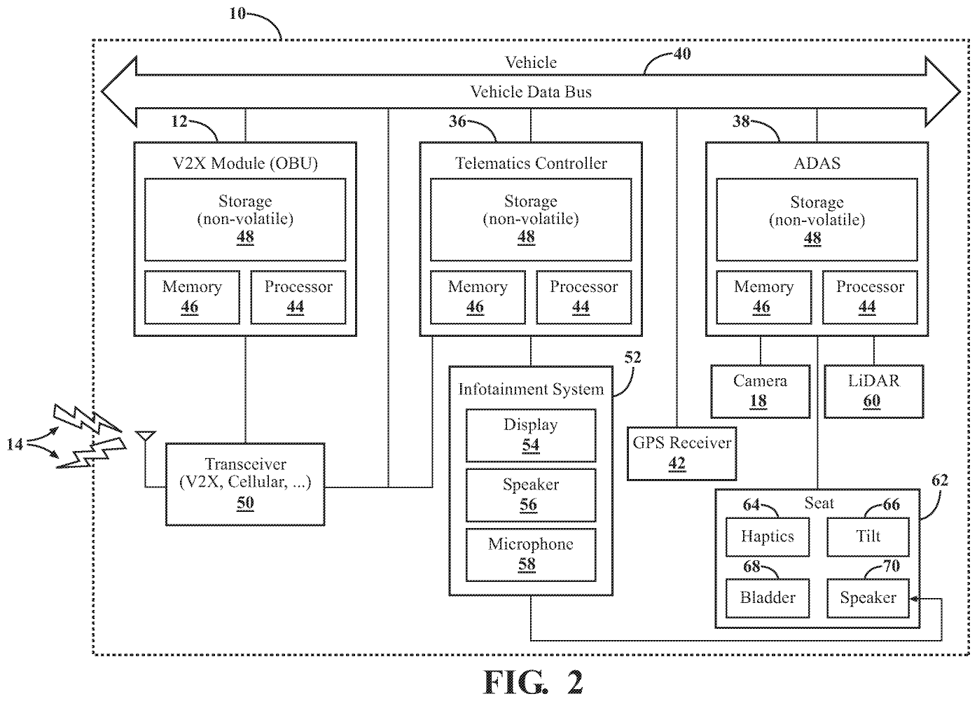

Referring next to FIG. 2, a simplified block diagram of one non-limiting exemplary embodiment of a driver assistance system for alerting a driver of a host vehicle according to the present disclosure is shown. As seen therein, a vehicle 10 may comprise an OBU 12, a telematics controller 36, and an advanced driver assistance system (ADAS) 38, each of which may be provided in communication with a vehicle data bus 40 (e.g., a Controller Area Network (CAN) bus) over which the OBU 12, the telematics controller 36, and the ADAS 38 may communicate with each other and with other components or systems of the vehicle 10 (e.g., speedometer, brake system, drive train, etc.). The vehicle 10 may also comprise a global positioning system (GPS) receiver 42, which may also be provided in communication with the vehicle data bus 40 for communicating with the OBU 12, the telematics controller 36, the ADAS 38, and/or any other components or systems of the vehicle 10.

Each of the OBU 12, the telematics controller 36, and the ADAS 38 may comprise one or more processors 44, as well as associated memory 46 and non-volatile storage 48 for storing suitable and appropriate computer executable instructions and data for the processors 44 to perform the control operations, functions, and/or algorithms described herein. In that regard, it should be noted that any unit, module, controller, system, subsystem, mechanism, device, component or the like described herein may comprise appropriate circuitry, such as one or more appropriately programmed processors (e.g., one or more microprocessors including central processing units (CPU)) (such as processors 44) and associated memory (such as memory 46 and/or storage 48), which may include stored operating system software and/or application software executable by the processor(s) for controlling operation thereof and for performing the particular algorithms represented by the various functions and/or operations described herein, including interaction between and/or cooperation with each other. One or more of such processors, as well as other circuitry and/or hardware, may be included in a single ASIC (Application-Specific Integrated Circuitry), or several processors and various circuitry and/or hardware may be distributed among several separate components, whether individually packaged or assembled into a SoC (System-on-a-Chip).

The OBU 12, which may alternatively be referred to as a V2X module, V2X system, or V2X communication unit, may also be provided in communication with a transceiver 50 configured to transmit and receive wireless signals 14 for communication with the OBUs 12 of other vehicles 10′, 10″ and/or with the RSUs 26 (see FIG. 1). In that regard, such wireless signals 14 may comprise the previously described DSRC wireless signals and/or cellular communication signals transmitted via wireless communication network or system 16 (see FIG. 1). The OBU 12 and/or ADAS 38 may be referred to or function as an interface to receive or for receiving an input signal including traffic condition information, which input signal may comprise a vehicle-to-x communication signal or a sensor signal from a host vehicle sensor adaptable to monitor a traffic condition.

Still referring to FIG. 2, the telematics controller 36 may be provided in communication with an infotainment system 52, which may comprise a display 54, a speaker 56, and a microphone 58. In that regard, the display 54 and/or the speaker 56 of the infotainment system 52 may be utilized to generate and/or provide the various driver alerts according to the embodiments of the driver assistance method and system of the present disclosure as described herein.

The ADAS 38 may be provided in communication with an on-board camera 18 and a LIDAR sensor 60. As previously described, the camera 18 and/or LiDAR sensor 60 may sense, detect, and/or provide information regarding the environment around the vehicle 10, which may include detecting (e.g., by capturing images of) a traffic signal, such as a STOP sign 20 or a traffic control light 22, or detecting a pedestrian 24 (see FIG. 1). Data or information provided by the camera 18 and/or LIDAR sensor 60 and/or V2X communications may be used by the ADAS 38 or another controller, control unit, or control module on-board the vehicle 10 to determine whether or not an object is present in front or in the planned path of the vehicle 10 and/or to identify any such object detected as a vehicle or a pedestrian, including determining and/or tracking the speed and direction of the detected object relative to the vehicle 10, according to any of the vehicle systems and methods for detecting, identifying and/or tracking objects that are well known to those of ordinary skill.

The ADAS 38 may further be provided in communication with a vehicle seat and/or seat controller 62, which may comprise a haptic motor 64, a seat tilt mechanism 66, an inflatable air bladder 68, and a speaker 70, which may be part of, integrated with, or operated in conjunction with the speaker 56 of the infotainment system 52. Here again, the haptic motor 64, tilt mechanism 66, bladder 68, and speaker 70 may be utilized to generate and/or provide the various driver alerts according to the embodiments of the driver assistance method and system of the present disclosure as described herein.

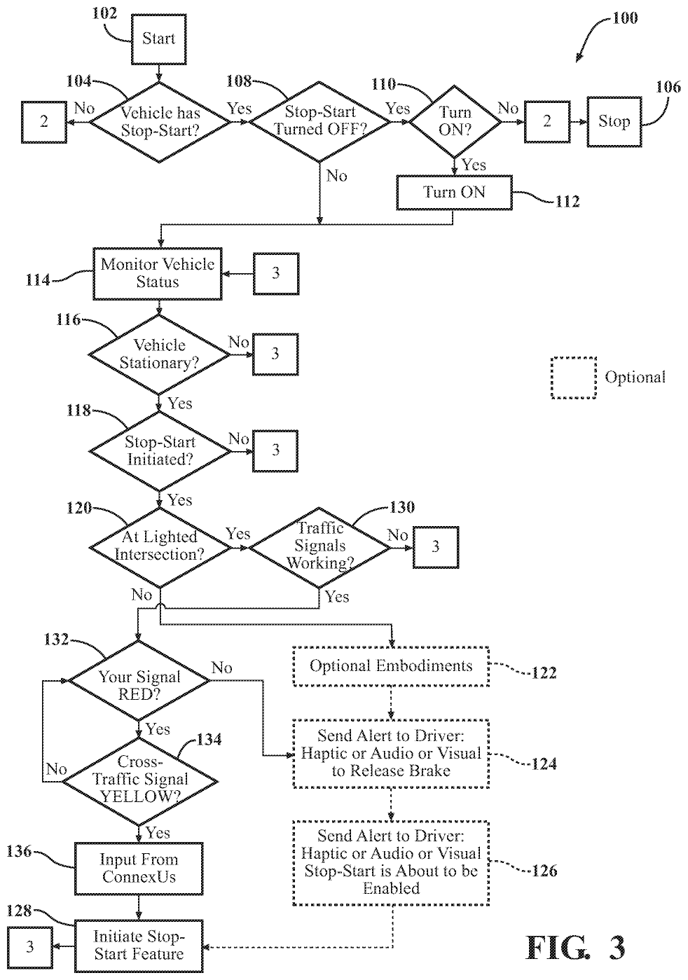

Referring now to FIG. 3, a simplified flowchart of one non-limiting exemplary embodiment of a method 100 for controlling a host vehicle start-stop system is shown. As seen therein, after start 102, a decision is made at 104 as to whether the host vehicle includes a start-stop system. If not, the method 100 ends at stop 106. Otherwise, a decision is made at 108 as to whether that host vehicle start-stop system is turned off, inactive, or has been deactivated. In that regard, as is well known to those of ordinary skill, a vehicle start-stop system may be automatically enabled by a vehicle controller and may be manually disabled by the host vehicle driver.

If a decision has been made at 108 that the host vehicle start-stop system is turned off, inactive, or has been deactivated, then a decision is made at 110 as to whether the host vehicle start-stop system should be, is to be, or will be turned on, activated, or reactivated. In that regard, according to one embodiment of the control method of the present disclosure, the host vehicle driver may be prompted for a decision and/or action to manually turn on, activate or reactivate the vehicle start-stop system within a predetermined period of time. If the host vehicle start-stop system is not manually turned on, activated, or reactivated, the method 100 ends at stop 106.

Alternatively, if at 112 the host vehicle start-stop system is turned on, activated, or reactivated, then at 114 a status of the host vehicle is monitored (e.g., whether the host vehicle is in motion or stationary, or whether or not the host vehicle driver has depressed the host vehicle brake pedal). Likewise, if it has been determined at 108 that the host vehicle start-stop system is not turned off, inactive, or has been deactivated (i.e., the host vehicle start-stop system is turned on or active), then a status of the host vehicle is also monitored at 114.

In that regard, still referring to FIG. 3, a decision is made at 116 as to whether the host vehicle is stationary. If not, then a status of the vehicle is again monitored at 114. Otherwise, if it is determined at 116 that the vehicle is stationary, then a decision is made at 118 as to whether the stop feature of the host vehicle start-stop system has been initiated (i.e., the vehicle engine has been or will be stopped, shut down, deactivated, or turned off). If not, then a status of the vehicle is again monitored at 114.

Otherwise, if it is determined at 118 that the stop feature of the host vehicle start-stop system has been initiated, then a decision is made at 120 as to whether the host vehicle is located at a road intersection controlled by a traffic light. If not, then optional embodiments 122 may be employed, as previously described. For example, an alert may be sent at 124 to the host vehicle driver, which alert may be haptic, audible, or visual, to release the brake pedal of the host vehicle. Alternatively, an alert may be sent at 126 to the host vehicle driver, which alert again may be haptic, audible, or visual, that the start feature of the vehicle start-stop system has been or is about to be initiated at 128.

If it is determined at 120 that the host vehicle is located at a road intersection controlled by a traffic light, then a decision is made at 130 as to whether the traffic light is working, operating, or properly functioning. If not, then a status of the vehicle is again monitored at 114. Otherwise, if it is determined at 130 that the traffic light is working, operating, or properly functioning, then a decision is made at 132 as to whether the light of the traffic signal controlling the lane of the roadway in which the host vehicle is located is red. If not, then optional embodiments 122 may again be employed, as previously described. For example, an alert may be sent at 124 to the host vehicle driver, which alert may be haptic, audible, or visual, to release the brake pedal of the host vehicle. Alternatively, an alert may be sent at 126 to the host vehicle driver, which alert again may be haptic, audible, or visual, that the start feature of the vehicle start-stop system has been or is about to be initiated at 128.

Otherwise, if it has been determined at 132 that the light of the traffic signal controlling the lane of the roadway in which the host vehicle is located is red, then a decision is made at 134 as to whether the light of the traffic signal controlling cross-traffic (relative to the host vehicle) is yellow. If not, then a decision is again made at 132 as to whether the light of the traffic signal controlling the lane of the roadway in which the host vehicle is located is red. Otherwise, if it has been determined at 134 that the light of the traffic signal controlling cross-traffic (relative to the host vehicle) is yellow, then traffic condition information is obtained at 136, such as from a V2X communication signal or V2X system (e.g., CONNEXUS′), which may indicate an impending change in the status of the light of the traffic signal controlling the lane of the roadway in which the host vehicle is located from red to green. As a result, the start feature of the host vehicle start-stop system may be initiated at 128.

In that regard, it should again be noted that the functions, operations, and/or algorithm(s) described herein, such as in connection with FIG. 3, may be accomplished by one or more processors 44, as well as associated memory 46 and non-volatile storage 48 for storing suitable and appropriate computer executable instructions and data for the processors 44 to perform those operations, functions, and/or algorithm(s). It should also again be noted that any unit, module, controller, system, subsystem, mechanism, device, component or the like described herein may comprise appropriate circuitry, such as one or more appropriately programmed processors (e.g., one or more microprocessors including central processing units (CPU)) (such as processors 44) and associated memory (such as memory 46 and/or storage 48), which may include stored operating system software and/or application software executable by the processor(s) for controlling operation thereof and for performing the particular algorithm(s) represented by the various functions and/or operations described herein, including interaction between and/or cooperation with each other. One or more of such processors, as well as other circuitry and/or hardware, may be included in a single ASIC (Application-Specific Integrated Circuitry), or several processors and various circuitry and/or hardware may be distributed among several separate components, whether individually packaged or assembled into a SoC (System-on-a-Chip). Moreover, as also previously noted, the control system and method of the present disclosure may utilize or include a controller with intelligence (e.g., an Advanced Driver Assistance System (ADAS) or other vehicle control and/or autonomous driving systems) well known to those of ordinary skill.

With reference now to FIGS. 1-3, a non-limiting exemplary embodiment of a method is provided for controlling a vehicle stop-start system having a stop stage in which an engine of a host vehicle is automatically stopped and a start stage in which the host vehicle engine is automatically restarted after the stop stage. As shown and described herein, the method may comprise receiving an input signal including traffic condition information, wherein the input signal comprises a vehicle-to-x communication signal or a sensor signal from a host vehicle sensor adaptable, adapted, configurable, or configured to monitor a traffic condition, such as a camera, RADAR, LIDAR, or other known sensor. In that regard, such a sensor may be dedicated to the control method of the present disclosure, or may be a host vehicle sensor provide for use by other host vehicle systems and borrowed or adapted by the control method of the present disclosure. The method may further comprise generating a control signal operative to automatically initiate the start stage of the vehicle stop-start system based on a determination that the traffic condition information of the input signal indicates an impending change in a traffic condition.

In that regard, as previously described, the impending change in the traffic condition may comprise an impending change of a status of a traffic signal. As also previously described, the impending change in the traffic condition may alternatively comprise an impending traffic condition wherein a roadway of the host vehicle is clear of an object. In that regard, the object may comprise a surrounding vehicle, a pedestrian, or a gate for railway tracks, as also described previously.

Moreover, the input signal may comprise the vehicle-to-x communication. In that regard, as described previously, the input signal may comprise a vehicle-to-vehicle communication, a vehicle-to-pedestrian communication, or a vehicle-to-infrastructure communication. The input signal may alternatively, or in addition, comprise the sensor signal from the host vehicle sensor.

The method may further comprise generating an alert signal operative to effectuate an alert for a driver of the host vehicle of an impending start of the vehicle engine. The method may further comprise, as previously described, delaying generation of the control signal operative to initiate the start stage of the vehicle start-stop system based on the input signal indicating that an object is present in a roadway of the host vehicle. As previously described, the alert may comprise an audible alert, a visual alert, or a haptic alert.

Referring still to FIGS. 1-3, a non-limiting exemplary embodiment of a system for controlling a vehicle stop-start system having a stop stage in which an engine of a host vehicle is automatically stopped and a start stage in which the host vehicle engine is automatically restarted after the stop stage. As shown and described herein, the control system may comprise an interface (e.g., OBU 12, ADAS 38) configured to receive an input signal including traffic condition information, wherein the input signal comprises a vehicle-to-x communication signal or a sensor signal from a host vehicle sensor adaptable, adapted, configurable, or configured to monitor a traffic condition (e.g., camera 18, LIDAR 60). Once again, such a sensor may be of any known type and may be dedicated to the control system of the present disclosure, or may be a host vehicle sensor provide for use by other host vehicle systems and borrowed or adapted by the control system of the present disclosure. The control system may further comprise a controller configured to generate a control signal operative to automatically initiate the start stage of the host vehicle stop-start system based on a determination that the traffic condition information of the input signal indicates an impending change in a traffic condition.

In that regard, as previously described, the impending change in the traffic condition may comprise an impending change of a status of a traffic signal. As also previously described, the impending change in the traffic condition may alternatively comprise an impending traffic condition wherein a roadway of the host vehicle is clear of an object. In that regard, the object may comprise a surrounding vehicle, a pedestrian, or a gate for railway tracks, as also described previously.

Moreover, the input signal may comprise the vehicle-to-x communication. In that regard, as described previously, the input signal may comprise a vehicle-to-vehicle communication, a vehicle-to-pedestrian communication, or a vehicle-to-infrastructure communication. The input signal may alternatively, or in addition, comprise the sensor signal from the host vehicle sensor.

The controller may be further configured to generate an alert signal operative to effectuate an alert for a driver of the host vehicle of an impending start of the vehicle engine. As previously described, the controller may be further configured to delay generation of the control signal operative to initiate the start stage of the vehicle start-stop system based on the input signal indicating that an object is present in a roadway of the host vehicle. As described previously, the alert may comprise an audible alert, a visual alert, or a haptic alert. The present disclosure also describes a vehicle comprising the control system described herein for controlling a vehicle stop-start system having a stop stage in which an engine of a host vehicle is automatically stopped and a start stage in which the vehicle engine is automatically restarted after the stop stage.

Still referring to FIGS. 1-3, a non-limiting exemplary embodiment of a non-transitory computer readable storage medium is provided having stored computer executable instructions for controlling a vehicle stop-start system having a stop stage in which an engine of a host vehicle is automatically stopped and a start stage in which the host vehicle engine is automatically restarted after the stop stage, the host vehicle having a controller and an interface configured to receive an input signal including traffic condition information, the input signal comprising a vehicle-to-x communication signal or a sensor signal from a host vehicle sensor adaptable to monitor a traffic condition. As shown and described herein, the computer executable instructions may be configured to cause the controller to generate a control signal operative to automatically initiate the start stage of the vehicle stop-start system based on a determination that the traffic condition information of the input signal indicates an impending change in a traffic condition.

It should be noted that an intersection may comprise a railroad crossing, a lighted intersection (i.e., and intersection having a traffic control light), or a non-lighted intersection (i.e., an intersection without a traffic control light or an intersection having a non-functional traffic control light). Moreover, a traffic signal may comprise any type of signal, such as a railway light, a traffic light, or a traffic sign (e.g., STOP sign). It should also be noted that the terms cross-traffic, cross, or crossing refer to any type of traffic or vehicle (including a rail vehicle) having an intended route/path or any roadway (including a railroad) that intersects or crosses the intended path/route or the roadway of the host vehicle in any way, regardless of the angle between such intended routes/paths or roadways.

It should also be noted that determining whether the host vehicle is stationary or moving may comprise monitoring the host vehicle for a release of a brake pedal, a depression of an accelerator pedal, or a speed in excess of a predetermined speed threshold. In that regard, such monitoring may be accomplished based on or using data communicated over a vehicle bus from a brake system, speedometer, drive train, or other host vehicle component or system.

It should still further be noted that determining whether an object is present in front of the host vehicle in the lane may comprise detecting an object in front of the host vehicle and/or identifying a detected object in front of the host vehicle as a vehicle and/or detecting that an object in front of the host vehicle is in motion. Determining whether an object is present in front of the host vehicle in the lane may comprise detecting and/or identifying on object as a pedestrian and/or detecting that a pedestrian is present in a planned path of the host vehicle.

As is readily apparent from the foregoing, various non-limiting exemplary embodiments of a system and method for controlling a vehicle stop-start system have been described. The system and method for controlling a vehicle stop-start system of the present disclosure receive traffic condition information from a vehicle-to-x communication signal or from a sensor signal from a host vehicle sensor adaptable to monitor a traffic condition. The control system and method also automatically initiate the start stage of the vehicle stop-start system based on a determination that the traffic condition information indicates an impending change in a traffic condition. By initiating the start stage of a vehicle start-stop system in such a fashion, the control system and method would reduce the latency of the start stage, which may help to eliminate accidents, improve traffic flow, and reduce the potential for road rage incidents.

While various embodiments have been illustrated and described herein, they are exemplary only and it is not intended that these embodiments illustrate and describe all those possible. Instead, the words used herein are words of description rather than limitation, and it is understood that various changes may be made to these embodiments without departing from the spirit and scope of the following claims.

1. A control system for controlling a vehicle stop-start system having a stop stage in which an engine of a host vehicle is automatically stopped and a start stage in which the host vehicle engine is automatically restarted after the stop stage, the control system comprising:
an interface configured to receive an input signal including traffic condition information, wherein the input signal comprises a vehicle-to-x communication signal or a sensor signal from a host vehicle sensor adaptable to monitor a traffic condition; and
a controller configured to generate a control signal operative to automatically initiate the start stage of the vehicle stop-start system based on a determination that the traffic condition information of the input signal indicates an impending change in a traffic condition.

2. The control system of claim 1 wherein the impending change in the traffic condition comprises an impending change of a status of a traffic signal.

3. The control system of claim 2 wherein the interface comprises a vehicle-to-x communication unit and the input signal comprises the vehicle-to-x communication signal.

4. The control system of claim 1 wherein the impending change in the traffic condition comprises an impending traffic condition wherein a roadway of the host vehicle is clear of an object.

5. The control system of claim 4 wherein the object comprises a surrounding vehicle, a pedestrian, or a gate for railway tracks.

6. The control system of claim 5 wherein the interface comprises a vehicle-to-x communication unit and the input signal comprises a vehicle-to-vehicle communication signal, a vehicle-to-pedestrian communication signal, or a vehicle-to-infrastructure communication signal.

7. The control system of claim 5 wherein the input signal comprises the sensor signal from the host vehicle sensor.

8. The control system of claim 1 wherein the controller is further configured to generate an alert signal operative to effectuate an alert for a driver of the host vehicle of an impending start of the vehicle engine.

9. The control system of claim 1 wherein the controller is further operative to delay generation of the control signal operative to initiate the start stage of the vehicle start-stop system based on the input signal indicating that an object is present in a roadway of the host vehicle.

10. A vehicle comprising the control system of claim 1 for controlling a vehicle stop-start system having a stop stage in which an engine of a host vehicle is automatically stopped and a start stage in which the vehicle engine is automatically restarted after the stop stage.

11. A method for controlling a vehicle stop-start system having a stop stage in which an engine of a host vehicle is automatically stopped and a start stage in which the host vehicle engine is automatically restarted after the stop stage, the method comprising:
receiving an input signal including traffic condition information, wherein the input signal comprises a vehicle-to-x communication signal or a sensor signal from a host vehicle sensor adaptable to monitor a traffic condition; and
generating a control signal operative to automatically initiate the start stage of the vehicle stop-start system based on a determination that the traffic condition information of the input signal indicates an impending change in a traffic condition.

12. The method of claim 11 wherein the impending change in the traffic condition comprises an impending change of a status of a traffic signal.

13. The method of claim 12 wherein the input signal comprises the vehicle-to-x communication.

14. The method of claim 11 wherein the impending change in the traffic condition comprises an impending traffic condition wherein a roadway of the host vehicle is clear of an object.

15. The method of claim 14 wherein the object comprises a surrounding vehicle, a pedestrian, or a gate for railway tracks.

16. The method of claim 15 wherein the input signal comprises a vehicle-to-vehicle communication, a vehicle-to-pedestrian communication, or a vehicle-to-infrastructure communication

17. The method of claim 15 wherein the input signal comprises the sensor signal from the host vehicle sensor.

18. The method of claim 11 further comprising generating an alert signal operative to effectuate an alert for a driver of the host vehicle of an impending start of the vehicle engine.

19. The method of claim 11 further comprising delaying generation of the control signal operative to initiate the start stage of the vehicle start-stop system based on the input signal indicating that an object is present in a roadway of the host vehicle.

20. A non-transitory computer readable storage medium having stored computer executable instructions for controlling a vehicle stop-start system having a stop stage in which an engine of a host vehicle is automatically stopped and a start stage in which the host vehicle engine is automatically restarted after the stop stage, the host vehicle having a controller and an interface configured to receive an input signal including traffic condition information, the input signal comprising a vehicle-to-x communication signal or a sensor signal from a host vehicle sensor adaptable to monitor a traffic condition, the computer executable instructions configured to cause the controller to:
generate a control signal operative to automatically initiate the start stage of the vehicle stop-start system based on a determination that the traffic condition information of the input signal indicates an impending change in a traffic condition.
